(19) United States
(12) Patent Application Publication
(10) Pub. No.: US 2014/0361657 A1
(43) Pub. Date: Dec. 11, 2014

(54) MAGNETIC CIRCUIT COMPRISING SECTORS

(71) Applicant: MOTEURS LEROY-SOMER, Angouleme (FR)

(72) Inventor: Patrick Vohlgemuth, La Rochefoucauld (FR)

(73) Assignee: MOTEURS LEROY-SOMER, Angouleme (FR)

(21) Appl. No.: 14/363,061

(22) PCT Filed: Dec. 4, 2012
(86) PCT No.: PCT/IB2012/056941

§ 371 Date: Jun. 5, 2014

(30) Foreign Application Priority Data
Dec. 5, 2011 (FR) 1161148

(51) Int. Cl. H02K 1/18; H02K 15/02; H02K 1/14

(52) U.S. Cl. CPC H02K 1/185; H02K 1/148; H02K 15/022
USPC 310/216.009; 29/596

(57) ABSTRACT

The invention relates to a magnetic circuit for a rotary electric machine, including: a plurality of packs of sheets stacked to form sectors, the facing sidewalls of said packs including nestable projections; and inserts introduced into housings defined at least partially by the nesting of the projections, said inserts being used to assemble the sectors to one another.

The present invention relates to rotating electric machines and, more particularly, the magnetic circuits of such machines.

The exciting inductive magnetic circuits conventionally consist of a stack of plates. These are very often cut adjoining from a strip whose width is substantially equal to the outer diameter of the inductor. The magnetic circuits may also be cut into segments. Each segment then forms an angular fraction of a complete revolution. The segments are then reassembled and stacked to form a complete magnetic circuit.

In the first case, the difference between the magnetic plate consumed and the material actually needed for the conduction of the magnetic flux is very great. It is not uncommon for the raw material used to represent twice the material that is useful to the passage of the flux.

In the second case, the production in segments makes it possible to minimize the material consumed because the smaller the angular portion of the segment, the smaller the amount of cutting waste. However, assembling, reconstructing a correct geometry and holding it during the winding operations are difficult. Generally, the smaller the angular portion covered by a segment, the more complex the production of the bundle of plates.

The invention aims to further refine the magnetic circuits of rotating electric machines and it achieves this by virtue of a magnetic circuit for a rotating electric machine, comprising a plurality of bundles of plates stacked in segments, having, on their facing flanks, nested reliefs, and inserts introduced into openings defined at least partially by the nesting of the reliefs, these inserts ensuring that the plates are joined together.

The invention makes it possible to fully exploit the reduction of material associated with the cutting in segments of the plates while having a joining of the segments that is simple, solid and of good quality.

The invention makes it possible notably to reconcile a minimal segment angular pitch with manufacturing simplicity, rigidity of the magnetic circuit and quality of assembly.

Preferably, the reliefs each have a hook shape, the concavities of two nested hooks being oriented one towards the other.

The shape of the reliefs is advantageously chosen such that it forces the segments together when the inserts are fitted.

The outer profile of the reliefs and that of the lateral notches in which they are received are preferably chosen such that there remains play between the reliefs and the notches after the nesting of the reliefs and before the fitting of the inserts, the latter resulting in the deformation of the reliefs and bringing the edges of the segments into abutment.

A bulge may be provided on each segment on its outer periphery, at the level of the reliefs, that is to say, occupying substantially the same angular position as the reliefs, about the axis of rotation of the machine.

The circuit preferably comprises holes for fastening the magnetic circuit to the machine, opening on the outer periphery of the segments, preferably in the form of a keyhole.

The magnetic circuit is preferably that of a stator, but it may also be that of a rotor.

Each bundle preferably comprises just one tooth of the magnetic circuit.

The flanks of the bundles can be arranged substantially midway between the teeth, within the magnetic circuit.

The openings may each have a substantially round shape.

The inserts preferably consist of rivets. The latter advantageously have at least one end headed against at least one bundle of plates.

Also the subject of the invention is a method for cutting segments of plates to produce a magnetic circuit as defined above, in which the segments are cut from a strip of plate by nesting two series of segments, with the teeth of one series of segments arranged between the teeth of the other series, the reliefs to be nested of one series being cut substantially midway between the reliefs to be nested of the other series.

Also the subject of the invention is a method for manufacturing a magnetic circuit, in which segments are joined by nesting reliefs and inserts are introduced into the duly created openings to keep the segments in the joined state. Preferably, the inserts consist of rivets which are radially expanded in the openings. Also preferably, the rivets are headed.

The invention will be able to be better understood from reading the following detailed description of an exemplary, nonlimiting implementation thereof, and by studying the appended drawing, in which:

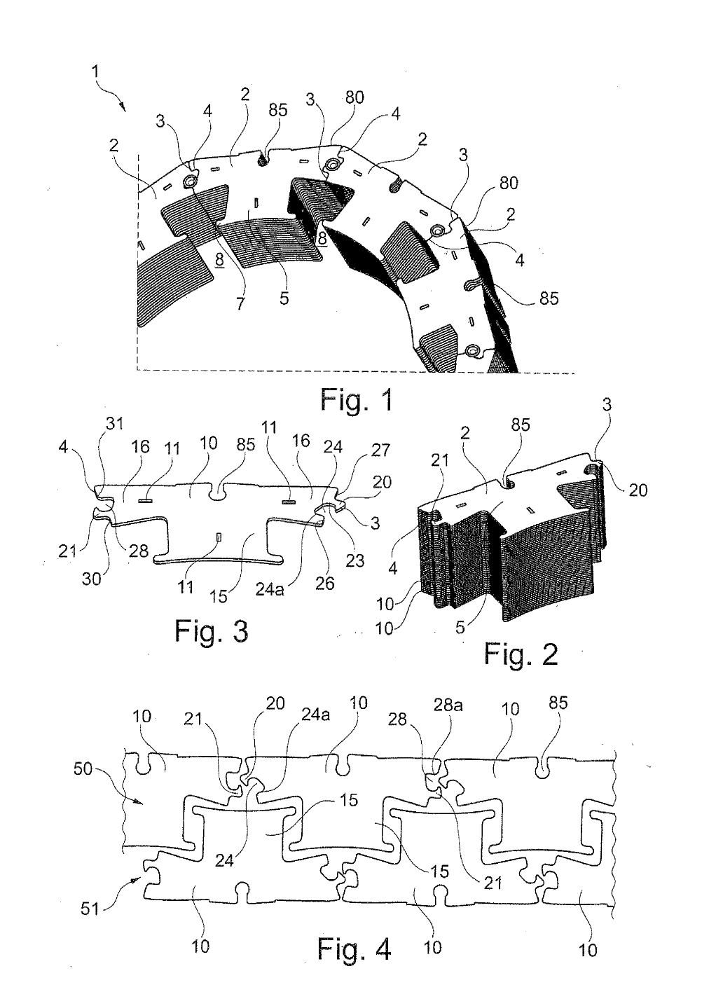

FIG. 1 represents, partially and schematically, an exemplary magnetic circuit according to the invention,

FIG. 2 represents, in isolation, a bundle of the magnetic circuit of FIG. 1,

FIG. 3 represents, in isolation, a plate of the bundle of FIG. 2,

FIG. 4 illustrates the cutting of the segments from a strip of plate,

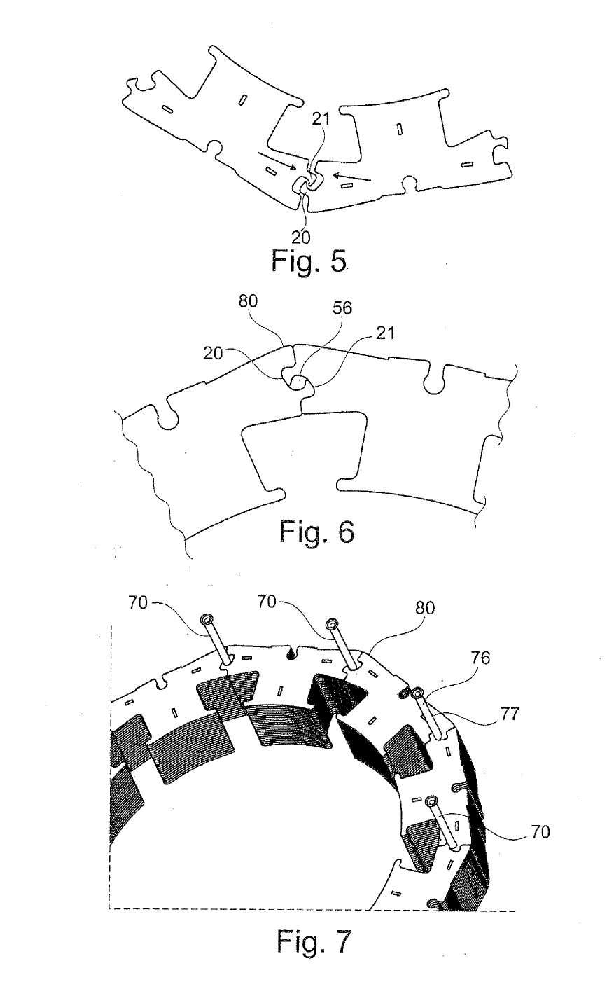

FIGS. 5 and 6 illustrate the nesting of the reliefs of the segments,

FIG. 7 illustrates the insertion of the rivets,

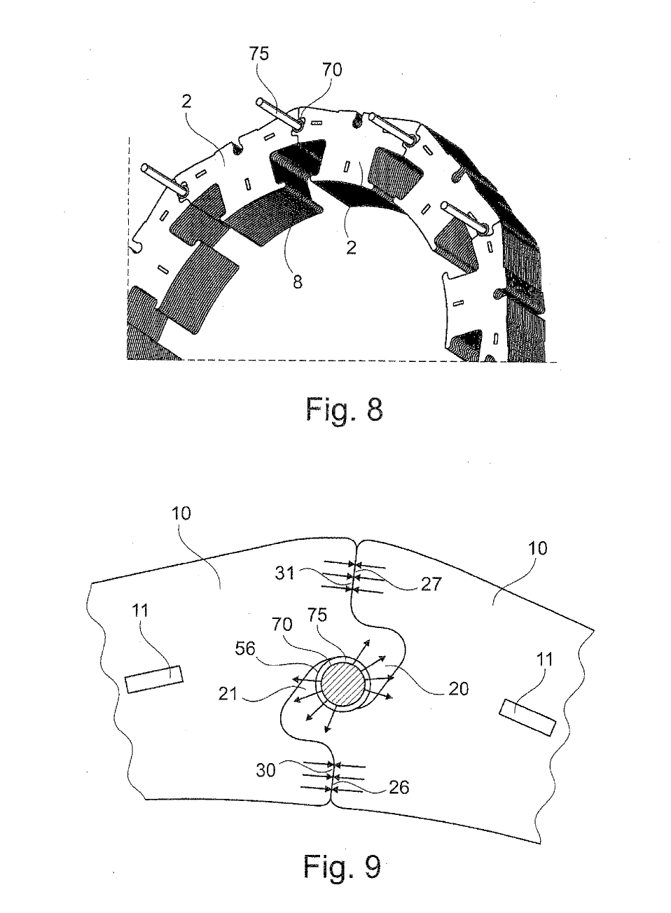

FIG. 8 illustrates the introduction of the pins into the rivets, and

FIG. 9 illustrates the convergence of the segments associated with the introduction of the pins.

The stator magnetic circuit 1 represented in FIG. 1 comprises bundles 2 joined together at their flanks. Each bundle 2 comprises one tooth 5 of the magnetic circuit, provided in the example illustrated with a pole shoe 7. As a variant, the teeth 5 have no pole shoes. The magnetic circuit 1 defines, between the teeth 5, notches 8 for receiving electrical conductors, which are not represented. The stator may have concentrated winding or distributed winding. Each bundle 2 is formed, as can be seen in FIG. 2, by the stacking of identical magnetic plates 10, in segments, one of which is represented in FIG. 3. These plates 10 are joined together by fitting clips in areas 11, in the conventional manner. The clipping areas 11 are, for example, located on the tooth 15 of each segment and on the annular yoke portions 16, intended to form the magnetic circuit behind the notches 8.

Reliefs 20 and 21 are made at the ends of these portions 16, respectively on the flanks 3 and 4, each being intended to be nested with a complementary relief of an adjacent segment.

The relief 20 which protrudes from the flank 3 has a hook shape of concavity 23 directed towards a lateral notch 24, the contour of which partially reproduces that of the relief 21. Edges 26 and 27, substantially aligned with one another, extend respectively towards the bottom of the notch of the magnetic circuit from the lateral notch 24 and radially towards the outside from the base of the hook 20.

The flank 4 comprises a lateral notch 28 in which the hook 20 of an adjacent plate can be engaged, and the relief 21 has a hook shape, the concavity of which is directed towards the lateral notch 28. This hook 21 is positioned on the flank 4 so as to be engaged in the lateral notch 24 of the adjacent plate, after the segments are joined together.

The lateral notch 24 has, on the side opposite to the hook 20, an edge 24a which is recessed. The same applies to the lateral notch 28, which has a recessed edge 28a on the side opposite to the hook 21. Each hook 20 or 21 has a body that is narrower than its head.

The outer profile of the hook 20 or 21 and that of the lateral notch 24 or 28 intended to receive it are preferably dimensioned such that there remains a very slight play in this area, notably between the summit of the hook and the edge of the lateral notch. This play is provided to favour a free contact between the edges 30 and 31 and the edges 26 and 27 of the segments upon the expansion of the inserts. Without this play, the joining together would risk being hyperstatic and it would be difficult to control the areas actually in contact and the areas with play. Under the expansion force, when the edges 30 and 31 are abutting with the edges 26 and 27 of the adjacent segments, the hooks 20 and 21 are deformed slightly, which minimizes the play initially provided between the hooks and the lateral notches. In this way, the air gap on the radial surfaces in contact, namely those of the edges 26, 27, 30 and 31, is cancelled. It should also be noted that, bearing in mind that there may remain a slight play around the hook, it is advantageous to produce a bulge 80 on the outside of the plate at the level of each hook, as illustrated in FIG. 6. In this way, the section of passage of the flux is increased in the area with no air gap to compensate the area disturbed by the presence of the hooks and any associated play. It should be noted that this bulge does not consume useful material since it is contained within the width of the strip used to produce the segments.

Edges 30 and 31 respectively prolong the hook 21 on the side of the bottom of the notch 8 of the magnetic circuit and the lateral notch 28 towards the outside.

The plates 10 are advantageously cut, as illustrated in FIG. 4, in two series 50 and 51 of segments, the latter being arranged within each series at regular intervals with the same orientation. The series of segments 50 and 51 are cut from a strip of plate whose width is less than twice the maximum radial dimension of a segment. The teeth 15 of the two series of segments are nested between one another.

The reliefs 20 and 21 of the segments of one series are positioned, in the longitudinal direction of the strip, substantially midway between the reliefs 20 and 21 of the segments of the other series.

The geometry of the hooks 20, 21 is such that the bundles 2 define between them, when the hooks are nested, openings 56, as illustrated in FIGS. 5 and 6. In particular, the concavity of each hook is substantially semicircular. Each lateral notch 24 or 28 has an opening that is sufficiently wide to allow for the passage of the head of the hook.

Tubular rivets 70 are introduced into the openings 56, as illustrated in FIG. 7.

Preferably, the profile of the plates is made such that the diameter of the openings 56 reconstituted between the hooks 20 and 21 allows for free insertion with play of the rivets 70.

The rivets used are, for example, of “rolled tubular” type with a longitudinal slot 77 offering a very wide expansion facility.

The force fitting of the pins 75 in the centre of the rivets 70 ensures the expansion of the latter, as illustrated in FIGS. 8 and 9, which causes the play to be taken up in the joining of the bundles. The segments are brought together when these rivets 70 are expanded. In this way, the lateral faces of one bundle are made to press strongly on the lateral faces of the adjacent bundles, reducing the undesirable air gaps in the magnetic circuit and ensuring a mechanical cohesion that is far superior to that obtained by conventional riveting. After the pins have been fitted, the second end of the rivets is advantageously headed on the bundles.

Two holding effects are then combined, the first being radial at the heart of the rivets which are expanded and the other longitudinal by crushing the rivet heads.

The radial holding effect ensures that each hook 20 or 21 is well applied against the edge of the lateral notch which receives it. The edges 26 and 27 bear against the edges 30, 31 and are radially oriented.

The pins are, for example, of “grooved pin” type, but other types of pins can do the job.

Tubular rivets produced from a material with a relatively low yield strength can be used as a variant.

The segments may include, as illustrated, holes 85 in the form of a keyhole, intended for the passage of screws, which will be used to fasten the inductor in the machine, generally on a rear flange. It is possible to have simple holes, not opening on the outer periphery.

The invention is not limited to the example illustrated.

The choice of the angle covered by a segment may be different, as may the choice of the place for cutting the segments, for example midway between the teeth.

The plates of a bundle may not be clipped together.

The expression “comprising a” should be understood to be synonymous with “comprising at least one”.

1-17. (canceled)

18. Magnetic circuit for a rotating electric machine, comprising a plurality of bundles of plates stacked in segments, having, on their facing flanks, nested reliefs, and inserts introduced into openings defined at least partially by the nesting of the reliefs, these inserts ensuring that the segments are joined together, the outer profile of the reliefs and that of the lateral notches in which they are received being configured such that there remains play between the reliefs and the notches after the nesting of the reliefs and before the fitting of the inserts, the latter resulting in the deformation of the reliefs and bringing the edges of the segments into abutment, the reliefs each having a hook shape, concavities of two nested hooks being oriented one towards the other.

19. Magnetic circuit for a rotating electric machine, comprising a plurality of bundles of plates stacked in segments, having, on their facing flanks, nested reliefs, and inserts introduced into openings defined at least partially by a nesting of the reliefs, these inserts ensuring that the segments are joined together, each bundle comprising just one tooth of the magnetic circuit.

20. Circuit according to claim 19, the reliefs each having a hook shape, concavities of two nested hooks being oriented one towards the other

21. Circuit according to claim 19, a shape of the nested reliefs forcing the segments together when the inserts are fitted.

22. Circuit according to claim 18, constituting the magnetic circuit of a stator.

23. Circuit according to claim 18, each bundle comprising just one tooth of the magnetic circuit

24. Circuit according to claim 23, the flanks of the segments being arranged substantially midway between the teeth of the segments.

25. Circuit according to claim 24, the openings each having a substantially round shape.

26. Circuit according to claim 18, the inserts consisting of rivets.

27. Circuit according to claim 26, the rivets having undergone a radial expansion.

28. Circuit according to claim 26, the rivets having at least one end headed against at least one bundle.

29. Circuit according to claim 18, comprising holes for fastening the magnetic circuit to the machine, opening on the outer periphery of the segments, preferably in the form of a keyhole.

30. Circuit according to claim 19, the outer profile of the reliefs and that of the lateral notches in which they are received being configured such that there remains play between the reliefs and the notches after the nesting of the reliefs and before the fitting of the inserts, the latter resulting in the deformation of the reliefs and bringing the edges of the segments into abutment.

31. Circuit according to claim 18, comprising a bulge on each segment, on its outer periphery, at the level of the reliefs.

32. Method for cutting segments to produce a magnetic circuit as defined in claim 18, in which the segments are cut from a strip of plate by nesting two series of segments, with the teeth of one series of segments arranged between the teeth of the other series, the reliefs to be nested of one series being cut substantially midway between the reliefs to be nested of the other series.

33. Method for manufacturing a magnetic circuit according to claim 18, in which segments are joined by nesting reliefs and inserts are introduced into the duly created openings to keep the segments in the joined state.

34. Method according to claim 33, the inserts consisting of rivets which are radially expanded in the openings

35. Method according to claim 34, the rivets being expended by inserting pins therein.

36. Method according to claim 34, the rivets also being headed.
